(19) United States
(12) Patent Application Publication
(10) Pub. No.: US 2020/0193280 A1
(43) Pub. Date: Jun. 18, 2020

(54) ADAPTATION OF MEMORY CELL STRUCTURE AND FABRICATION PROCESS TO BINARY DATA ASYMMETRY AND BIT-INVERSION TOLERANCE ASYMMETRY IN DEEP LEARNING MODELS

(71) Applicant: Gyrfalcon Technology Inc., Milpitas, CA (US)

(72) Inventors: Chyu-Jiuh Torng, Dublin, CA (US); Hualiang Yu, San Jose, CA (US); Wenhan Zhang, Mississauga (CA); Daniel H. Liu, San Jose, CA (US)

(73) Assignee: Gyrfalcon Technology Inc., Milpitas, CA (US)

(21) Appl. No.: 16/217,731

(22) Filed: Dec. 12, 2018

(51) Int. Cl. G06N 3/08; G06N 5/02

(52) U.S. Cl. CPC G06N 3/08; G06N 5/02

(57) ABSTRACT

This disclosure relates to artificial intelligence (AI) circuits with embedded memory for storing trained AI model parameters. The embedded memory cell structure, device profile, and/or fabrication process are designed to generate binary data access asymmetry and error rate asymmetry between writing binary zeros and binary ones that are adapted to and compatible with a binary data asymmetry of the trained model parameters and/or a bit-inversion tolerance asymmetry of the AI model between binary zeros and ones. The disclosed method and system improves predictive accuracy and memory error tolerance without significantly reducing an overall memory error rate and without relying on memory cell redundancy and error correction codes.

### TECHNICAL FIELD

This disclosure generally relates to adaptive design, fabrication, and utilization of memory embedded in integrated circuits and designed for artificial intelligence (AI) applications.

### BACKGROUND

Deep learning models that are trained and deployed with, e.g., convolutional neural networks (CNNs), may include many convolutional layers, pooling layers, rectification layers, and fully connected layers, and generally require millions of, if not more, trained model parameters for processing complex input data such as images, speeches, and natural languages. Deployment of such a model thus requires massive amount of memory cells for storing the trained model parameters. Writing or reading errors may occur in these memory cells. The reading or writing errors may be asymmetric with respect to the binary values of the data stored in the memory cells due to asymmetry in memory writing or reading operations. For example, in some type of memory cells, errors may occur with a higher rate for writing zeros than for writing ones, or vice versa. Likewise, in some type of memory cells, errors may occur with a higher rate for reading zeros than for reading ones, or vice versa. As such, memory cells may be characterized by data writing asymmetry, data reading asymmetry, and corresponding writing error asymmetry and reading error asymmetry. The data writing asymmetry and data readying asymmetry may be combined into an effective data access asymmetry. The writing error asymmetry and reading error asymmetry may likewise be combined into an effective data access error asymmetry. Traditional technology has been directed to designing and fabricating memory cells with reduced overall reading or writing error regardless of the error asymmetry. In the meanwhile, a deep learning model may have error-tolerance asymmetry in that errors in bits of the model parameters having one value of the two binary values (zero or one) may statistically cause less output error (e.g., misclassification of input by a deep learning classifier) leading to higher error-tolerance compared to errors in bits of the model parameters having the other opposite value of the two binary values.

### SUMMARY

This disclosure is directed to adjusting memory cell design and fabrication process to deliberately achieve a desired level of memory reading and writing asymmetry between binary ones and binary zeros such that predictive accuracy of a deep learning model having model parameters stored in the memory cells with asymmetric binary data and asymmetric error-tolerance may be improved in the presence of reading and writing errors. Such improvement may be achieved without having to improve an overall memory error rate and without having to rely on memory cell redundancy and error correction codes. Further objects, features, and advantages of this disclosure will become readily apparent to persons having ordinary skill in the art after a review of the following description, with reference to the drawings and claims that are appended to and form a part of this specification.

In one implementation, a method for classifying input data into a set of classes is disclosed. The method includes training a convolutional neural network (CNN) model using a set of training input data each labeled with one of the set of classes to obtain a plurality of model parameters; determining a data preference measure of the model parameters; and determining an acceptable range of memory cell data access asymmetry according to the data preference measure of the model parameters. The method further include adjusting memory cell design and fabrication process to generate an array of memory cells having a data access asymmetry within the acceptable range of memory cell data access asymmetry; embedding the array of memory cells with an artificial intelligence (AI) logic circuit to form an AI device; loading the trained CNN model into the AI device by at least loading the model parameters with the data preference measure into the array of memory cells having the data access asymmetry; and forward-propagate an input data through the trained CNN model using the model parameters loaded in the array of memory cells to determine an output class among the set of classes for the input data.

In the implementation above, the data preference measure of the model parameters may quantify an imbalance between a number of zeros and a number of ones of the model parameters each expressed in a predetermined multi-bit binary form, or may quantifies a bit-inversion tolerance asymmetry of the CNN model.

In the implementations above, the bit-inversion tolerance asymmetry of the CNN model may be determined by repeatedly inverting a predetermined number of bits of the model parameters having a value of zero to one to generate statistically a first prediction error rate of the CNN model using the set of training input data and the zero-to-one inverted model parameters; repeatedly inverting a predetermined number of bits of the model parameters having a value of one to zero to generate statistically a second prediction error rate of the CNN model using the set of training input data and the one-to-zero inverted model parameters; and determining an imbalance between the first prediction error rate and the second prediction error rate as the bit-inversion tolerance asymmetry of the CNN model.

In the implementations above, the data preference measure of the model parameters may quantify a composite of a bit-inversion tolerance asymmetry of the CNN model and an imbalance between a number of zeros and a number of ones of the model parameters each expressed in a predetermined multi-bit binary form.

In the implementations above, each memory cell of the array of memory cells may include a magnetic tunnel junction comprising a thin insulating layer sandwiched by a permanent ferromagnetic plate and a writable ferromagnetic plate.

In the implementations above, the data access asymmetry comprises an asymmetry between error rate in writing binary one and error rate in writing binary zero.

In another implementation, a method for classifying input data into a set of classes is disclosed. The method includes training a CNN model using a set of training input data each labeled with one of the set of classes to obtain a plurality of model parameters; dividing the plurality of model parameters into a first group of model parameters with a first data preference measure and a second group of model parameters with a first data preference measure opposite to the first data preference measure; adjusting memory cell design and fabrication process to generate an array of memory cells comprising a first set of memory cells having a first data access asymmetry and a second set of memory cells having a second data access asymmetry opposite to the first data access asymmetry; embedding the array of memory cells with an AI logic circuit to form an AI device; loading the trained CNN model into the AI device by at least loading the first group of model parameters into the first set of memory cells and the second group of model parameters into the second set of memory cells; and forward-propagate an input data through the trained CNN model using the model parameters loaded in the array of memory cells to determine an output class among the set of classes for the input data.

In the implementation above, the data preference measure of the model parameters may quantify an imbalance between a number of zeros and a number of ones of the model parameters each expressed in a predetermined multi-bit binary form, or may quantify a bit-inversion tolerance asymmetry of the CNN model.

In the implementations above, the bit-inversion tolerance asymmetry of the CNN model is determined by repeatedly inverting a predetermined number of bits of the model parameters having a value of zero to one to generate statistically a first prediction error rate of the CNN model using the set of training input data and the zero-to-one inverted model parameters; repeatedly inverting a predetermined number of bits of the model parameters having a value of one to zero to generate statistically a second prediction error rate of the CNN model using the set of training input data and the one-to-zero inverted model parameters; and determining an imbalance between the first prediction error rate and the second prediction error rate as the bit-inversion tolerance asymmetry of the CNN model.

In the implementations above, the data preference measure of the model parameters quantifies a composite of a bit-inversion tolerance asymmetry of the CNN model and an imbalance between a number of zeros and a number of ones of the model parameters each expressed in a predetermined multi-bit binary form.

In the implementations above, each memory cell of the array of memory cells comprises a magnetic tunnel junction comprising a thin insulating layer sandwiched by a permanent ferromagnetic plate and a writable ferromagnetic plate.

In the implementations above, the first data access asymmetry and the second data access asymmetry each comprises an asymmetry between error rate in writing binary one and error rate in writing binary zero.

In another implementation, a method for classifying input data into a set of classes is disclosed. The method include training a CNN model using a set of training input data each labeled with one of the set of classes to obtain a plurality of model parameters; determining a data preference measure of the model parameters; determining a data access asymmetry of an array of memory cells embedded with an AI logic circuit in an AI device; determining whether the data preference measure is compatible with the data access asymmetry. The method further include, when the data preference measure is not compatible with the data access asymmetry, setting a data inversion flag; inverting each binary bit of the model parameters to generated an inverted model parameters; loading the trained CNN model into the AI device by at least loading the inverted model parameters into the array of memory cells. The method further includes when the data preference measure is compatible with the data access asymmetry, loading the trained CNN model into the AI device by at least loading the model parameters into the array of memory cells. The method additionally includes forward-propagate an input data through the trained CNN model using the model parameters loaded in the array of memory cells when the data inversion flag is not set, and using the inverted model parameters followed by binary inversion when the data inversion flag is set to determine an output class among the set of classes for the input data.

In the implementations above, the data preference measure of the model parameters quantify an imbalance between a number of zeros and a number of ones of the model parameters each expressed in a predetermined multi-bit binary form, or may quantify a bit-inversion tolerance asymmetry of the CNN model.

In the implementations above, the bit-inversion tolerance asymmetry of the CNN model may be determined by repeatedly inverting a predetermined number of bits of the model parameters having a value of zero to one to generate statistically a first prediction error rate of the CNN model using the set of training input data and the zero-to-one inverted model parameters; repeatedly inverting a predetermined number of bits of the model parameters having a value of one to zero to generate statistically a second prediction error rate of the CNN model using the set of training input data and the one-to-zero inverted model parameters; and determining an imbalance between the first prediction error rate and the second prediction error rate as the bit-inversion tolerance asymmetry of the CNN model.

In the implementations above, the data preference measure of the model parameters quantifies a composite of a bit-inversion tolerance asymmetry of the CNN model and an imbalance between a number of zeros and a number of ones of the model parameters each expressed in a predetermined multi-bit binary form.

In the implementations above, the data access asymmetry includes an asymmetry between error rate in writing binary one and error rate in writing binary zero.

### BRIEF DESCRIPTION OF THE DRAWINGS

FIG. 1 shows an architectural diagram of an exemplary artificial intelligence (AI) engine with embedded memory for storing AI model parameters.

FIG. 2 illustrates an exemplary convolutional neural network (CNN) model having various types of model parameters that may be stored in the embedded memory of FIG. 1.

FIG. 3 illustrates various binary data asymmetries for model parameters of exemplary CNN models.

FIG. 4 illustrates an exemplary magnetic random access memory (MRAM) cell structure for storing CNN model parameters with data access error asymmetry that may be adjusted.

FIG. 5 shows an exemplary logic flow for adjusting memory cell structure design and adapting fabrication process for the memory cells to binary data asymmetry in the model parameters of a CNN model.

FIG. 6 shows an exemplary logic flow for adjusting memory cell structure design and adapting fabrication process for the memory cells to bit-inversion tolerance asymmetry in a CNN model.

FIG. 7 shows an exemplary logic flow for adjusting memory cell structure design and adapting fabrication process for memory cells to a composite data preference measure combining both the binary data asymmetry of the model parameters in FIG. 5 and the bit-inversion tolerance asymmetry of the CNN model in FIG. 6.

FIG. 8 illustrates another exemplary logic follow for fabricating memory cells with mixed data access asymmetries and using memory cells of different data access asymmetries for storing model parameters with different binary data asymmetries.

FIG. 9 illustrates another exemplary logic follow for fabricating memory cells with mixed data access asymmetries and using memory cells of different data access asymmetries for storing model parameters of a CNN model with different bit-inversion tolerance asymmetries.

FIG. 10 illustrates another exemplary logic follow for fabricating memory cells with mixed data access asymmetries and using memory cells of different data access asymmetries for storing model parameters with different composite data preference measures.

FIG. 11 illustrates another exemplary logic follow for using memory cells having a predetermined data access asymmetry by adapting the binary data for the model parameters for storage in the memory cells.

### DETAILED DESCRIPTION

Artificial intelligence techniques have been widely used for processing large amount of input data to extract categorical and other information. These techniques, in turn, may then be incorporated into a wide range of applications to perform various intelligent tasks. For example, deep learning techniques based on convolutional neural networks (CNNs) may provide trained CNN models for processing particular types of input data. For example, a CNN model trained for classifying images may be used to analyze an input image and determine a category of the input image among a predetermined set of image categories. For another example, a CNN model may be trained to produce segmentation of an input image in the form of, e.g., output segmentation masks. Such segmentation masks, for example, may be designed to indicate where particular types of objects are in the image and their boundaries.

A deep learning CNN model, may typically contain multiple cascading convolutional, pooling, rectifying, and fully connected layers of neurons, with millions of kernel, weight, and bias parameters. These parameters may be determined by training the model using a sufficient collection of labeled input data. Once a CNN model is trained and the model parameters are determined, it may be used to process unknown input data and to predict labels for the unknown input data. These labels may be classification labels, segmentation masks, or any other type of labels for the input data.

In a training process of a CNN model, each of a large number of labeled training datasets is forward propagated through the layers of neurons of the CNN network embedded with the training parameters to calculate an end labeling loss. Back propagation is then performed through the layers of neurons to adjust the training parameters to reduce labeling loss based on gradient descent. The forward/back propagation training process for all training input datasets iterates until the neural network produces a set of training parameters that provide converging minimal overall loss for the labels predicted by the neural network over labels given to the training datasets. A converged model then includes a final set of training parameters and may then be tested and used to process unlabeled input datasets via forward propagation. Such a CNN model typically must be of sufficient size in terms of number of layers and number of neurons/features in each layer for achieving acceptable predictive accuracy. The number of training parameters is directly correlated with the size of the neural network, and is typically extraordinarily large even for a simple AI model (on the order of millions, tens of millions, hundreds of millions, and thousands of millions of parameters). The forward and back propagations thus require a massive amount of memory to hold these parameters and extensive computation power for iteratively calculating states of a massive number of neurons.

The training process for a CNN model is thus typically handled by centralized or distributed backend servers having sufficient memory and computing power in order to train the CNN model in a reasonable amount of time. These calculations may be performed by special co-processors included in the backend servers that support parallel data processing. For example, a Graphics Processing Unit (GPU) with large embedded memory or with external memory connected to the GPU core via high speed data buses may be included in the backend servers and used to accelerate the forward/back propagations in neural networks, thanks to similarity in parallel data manipulation between graphics data and neural networks.

Once trained, a CNN model may be deployed in the backend servers and provided as a service, taking advantage of the memory capacity and the parallel computing power of the backend servers. The service would include forward propagating an input dataset through the layers of neurons of the trained CNN model to obtain an output label for the input dataset. Such a service may be provided to edge devices. Edge devices may include but are not limited to mobile phones and any other devices, such as Internet-of-Things (IoT) devices. These devices may be designed to handle limited tasks and with limited computing power and memory capacity, and thus incapable of efficiently performing forward propagation locally. As such, these edge devices may communicate with the backend servers via communication network interfaces to provide input datasets to the backend servers and obtained labels for the input datasets from the backend server after the input datasets are processed by the CNN model in the backend servers.

In many applications, local processing of the input data may be desired. For example, when an input dataset is large (e.g., high-resolution 2D or 3D images), transmission of the input dataset from the edge device to the backend servers may consume an unacceptable or unsupported level of communication bandwidth and/or power. Further, some edge devices may have only intermittent communication network connection or no communication network connection at all.

In such applications, the CNN model may reside on the edge devices. As such, the edge devices designed for these applications may include sufficient memories adapted to the needs for storing various types of model parameters of the CNN model. These memories may further be embedded with a CNN logic circuit on a same semiconductor substrate for reducing power dissipation, reducing latency, and increasing data access speed. These embedded memories may be of single type or mixed types, as disclosed, for example, in the U.S. patent application Ser. Nos. 16/050,679, 15/989,515, 15/838,131, 15/726,084, 15/642,100, 15/642,076 filed respectively on Jul. 31, 2018, May 25, 2018, Dec. 11, 2017, Oct. 5, 2017, Jul. 5, 2017, and Jul. 5, 2017, which are herein incorporated by reference in their entireties.

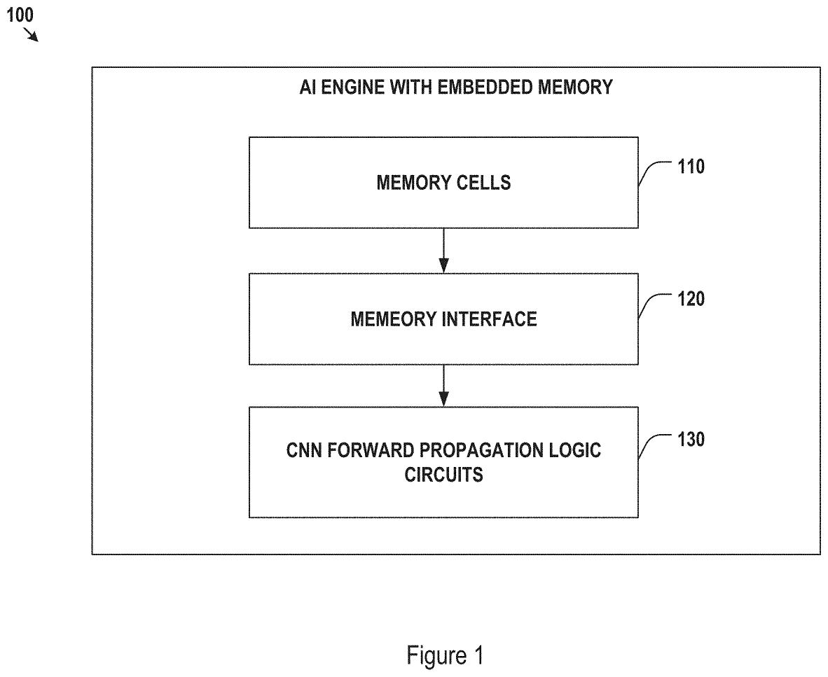

An example of a core AI engine with embedded memory for such an edge device is shown in FIG. 1. The memory may be implemented as memory cells 110 embedded with the AI engine or CNN logic circuits 130. In some implementations, an embedded memory interface 120 may be used to facilitate the data access by the AI logic circuits 130. The AI logic circuits may be specifically designed to provide parallel processing of various forward propagation paths through the layers of neurons of the CNN network. The memory cells 110 may be a single type or mixed types of memories adapted to needs of various types of model parameters with respect to, e.g., access frequency, access speed, and persistency.

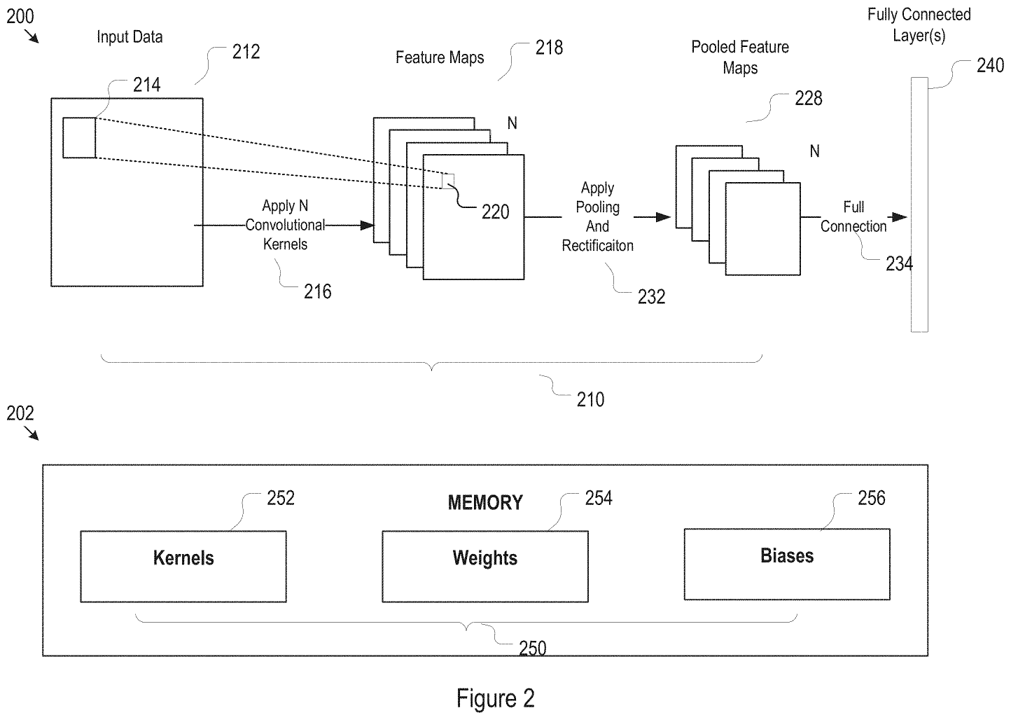

FIG. 2 illustrates a simplified exemplary CNN model 200 and storage of the model parameters in embedded memory 202. For example, the CNN model may include multiple repetitions/cascading of convolution, pooling, and rectification layers 210. For simplicity, FIG. 2 only shows one of such repetitions. In particular, the CNN model may include a feature extraction layer for perform sliding convolution 216 across the input data 212 between a plurality (N) of features 214 (one feature is shown) with the input data 212 (shown as a two dimensional data matrix in this example), generating N feature maps 218. These features 214 may be alternatively referred to as convolution kernels 214. Each convolution between a kernel 214 and a portion of the input data 212 is represented by 220. The number of Feature maps (N) is determined by a number of features. The feature maps 218 may then be pooled (e.g., via max pooling) and rectified (232) to generate pooled feature maps 228, The convolutional, pooling and rectification layers 210 may be repeated multiple times and final pooled feature maps 228 may then be mapped via connection 234 to fully connected layer 240, containing, for example, output categories. The fully connected layer 240, in turn, may include multiple stacked hidden layers (not shown) before the final category layer.

The CNN model 200 is essentially manifested as a set of model parameters 250, these parameters may include but are not limited to the convolution features or kernels 214, the weights and biases for the various connections between neurons within the fully connected layer 240. These model parameters may be stored in the embedded memory 202 as convolutional kernels 252, weights 254, and biases 256.

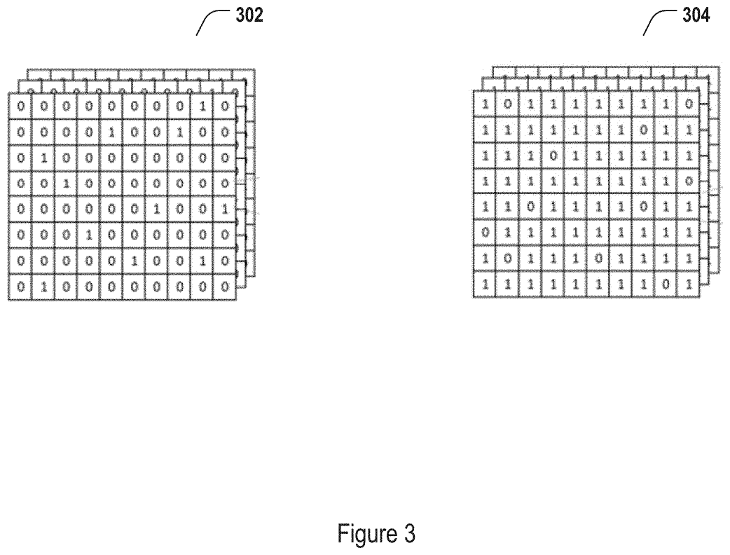

The model parameters 250 of FIG. 2 may be stored in the memory 202 in a binary form, as shown in FIG. 3. The model parameters of a particular CNN model may be characterized by a binary data asymmetry. In particular, a CNN model for some applications may include trained model parameters that are zero-dominant in binary form. An example of such a zero-dominant model parameters in binary form is shown in 302 of FIG. 3. For some other applications, a CNN model may include trained model parameters that are one-dominant instead. An example of such a one-dominant model parameters in binary form is shown in 304 of FIG. 3. Such binary data asymmetry of the model parameters may be quantified by an imbalance between the number of binary zeros and number of binary ones for the model parameters in binary form. Such quantification may be relative, e.g., in percentage of imbalance relative to a total number binary bits for the model parameters.

Further, such binary data asymmetry may vary for different types of parameters within a same CNN model. For example, in a particular CNN model, the convolutional kernel model parameters (252 of FIG. 2) may be binarily symmetric, whereas the weight model parameters (254 of FIG. 2) may be zero-dominant, yet the bias model parameters (256 of FIG. 2) may be one-dominant. As such, binary asymmetry for different types of model parameters for a particular CNN model may be separately quantified as imbalance of zeros and ones within each type of model parameters.

Independent of potential binary data asymmetry for the model parameters, a CNN model may be further characterized by one or more bit-inversion tolerance characteristics and corresponding bit-inversion tolerance asymmetry. The bit-inversion tolerance characteristics may be used to characterize how likely the CNN model would make wrong prediction output when one or more wrong bits of the model parameters are used in the forward propagation. Bit-inversion may include either zero-to-one inversion (a bit having a zero value is written or read mistakenly as one) or one-to-zero inversion (a bit having a one value is written or read mistakenly as zero). A CNN may have statistically different tolerance level between zero-to-one inversion and one-to-zero inversion, represented by a bit-inversion tolerance asymmetry. The bit-inversion tolerance characteristics as well as asymmetry may differ as to different types of model parameters. For example, in a particular CNN model, the kernel model parameters (252 of FIG. 2) may be characterized by a first zero-to-one bit-inversion tolerance characteristic, a first one-to-zero bit-inversion tolerance characteristic, and correspondingly a first bit-inversion tolerance asymmetry, whereas the weight model parameters (254 of FIG. 2) may be characterized by a second zero-to-one bit-inversion tolerance characteristic, a second one-to-zero bit-inversion tolerance characteristic, and correspondingly a second bit-inversion tolerance asymmetry, whereas the bias model parameters (256 of FIG. 2) may be characterized by a third zero-to-one bit-inversion tolerance characteristic, a third one-to-zero bit-inversion tolerance characteristic, and correspondingly a third bit-tolerance asymmetry.

The bit-inversion tolerance characteristics and asymmetry may be determined for a particular trained CNN model statistically. In one implementation for determining an overall zero-to-one bit-inversion tolerance characteristics for the trained CNN model, a predetermined number of zero bits in the model parameters may be intentionally inverted to ones in a random manner among all bits of all model parameters. The randomly inverted model parameters may then be used for forward propagation of the training data (or other pre-labeled data not used for training) to produce outputs. Prediction error rate (as determined by comparing the outputs to pre-labels) may be recorded for a set of input data. The process may be repeated for different set of random zero-to-one inversions of the same predetermined number of inverted bits. The process above may further be repeated for inverting different predetermined numbers of bits (one bit, 2 bit, 3 bit, etc.). The various error rates determined above for different number of inverted bits may be weight-averaged (or collectively processed in other manner) to represent the overall zero-to-one bit-inversion tolerance characteristics for the trained model. This determination process may be performed by a sufficiently reliable system. In other words, the system used for such determination may not introduce other unpredicted errors in any significant manner.

The process for determining the overall bit-inversion tolerance characteristics of the trained CNN model may be performed similarly for one-to-zero inversion to obtain an overall one-to-zero bit-inversion tolerance characteristics. Furthermore, the above process for determining bit-inversion tolerance characteristics may be performed separated for each type of model parameters and separately for one-to-zero bit-inversion tolerance and for zero-to-one bit-inversion tolerance. Once the various bit-inversion tolerance characteristics are obtained, an overall bit-inversion tolerance asymmetry for all model parameters or separate bit-inversion tolerance asymmetries for different types of model parameters may be determined. A bit-inversion tolerance asymmetry, for example, may be quantified as relative error rate ratio between a zero-to-one bit-inversion prediction error rate and a one-to-zero bit-inversion prediction error rate.

When a CNN model is deployed in a non-ideal system, memory writing and/or reading errors may occur. These writing and/or reading errors lead to either wrong model parameters being stored in the memory or lead to wrongly read parameters even though the parameters may be stored correctly in the memory. For simplicity of discussion, the disclosure below will primarily focus on memory data writing errors. The underlying principles discussed below applies to memory data reading errors. The memory data writing errors and reading errors may be combined into an effective memory access errors, and these principles disclosed below also applies to memory data access errors.

Data writing/reading of a memory may be asymmetric between writing/reading of ones and writing of zeros. For different memory technologies, different memory cell architectures, different material compositions, and different fabrication processes, the data writing/reading asymmetry (or data access asymmetry) may vary. Data writing/reading asymmetry may include but is not limited to current, voltage, and timing asymmetry for writing/reading zeros and ones. Data writing/reading asymmetry may cause writing/reading error asymmetry (or data access error asymmetry) in inadvertent writing/reading error rates for ones and zeros. For example, the memory cells may need higher programing current for writing ones than zeros, and if the same current is being used for programing zeros and ones, then more errors (higher error rate) may be made when writing ones than zeros,

Furthermore, memory cells, once being written, may be subject to inadvertent bit inversion due to environmental influences such as thermal effect, external radiation, external static electric and/or magnetic field. Such inadvertent inversion may be asymmetric for zeros and ones. For example, zeros in the memory cells, once written, may be more robust against environmental influences than ones, or vice versa. To simplify the discussions below, the writing/reading error asymmetry and the asymmetry for environment-induced memory bit inversion may be categorically referred to as writing/reading error asymmetry (or alternatively, data access error asymmetry).

In traditional application of memories, writing/reading errors for both zeros and ones may be reduced sufficiently to a level where any data access error asymmetry becomes unimportant to system performance. In AI applications, however, memories for storing model parameters for AI models may be more error tolerant compared to other applications, particularly for AI models having limited number of possible outputs (e.g., limited number of classification categories). For example, the model parameters may be 1%-5% wrong, yet the model may still produce correct output classification. As such, memories with high error rates may nevertheless be usable for AI application. At these high error rates, memory data access error asymmetry may become particularly important, as it may significantly affect the accuracy of an AI model, particularly if the AI model is asymmetric as to bit-inversion tolerance. Because memory data access error asymmetry may be adjusted by designing the memory cell structure, profile, material composition, and fabrication process (as described in more detail below in the context of MRAM), such design adjustment may be taken into consideration in view of characteristics of the AI data model and model parameters for further improving prediction accuracy and error tolerance of the model, even when such consideration may not improve the overall error rate of the memory.

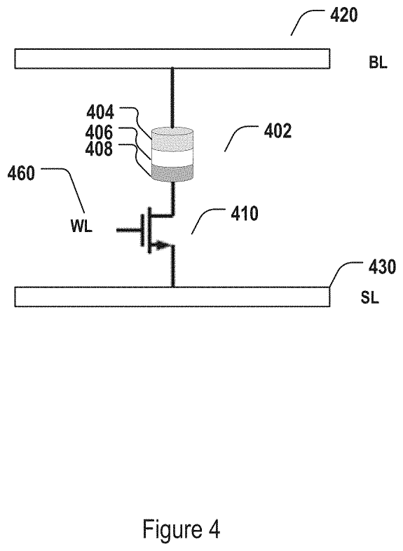

FIG. 4 illustrates an exemplary a memory cell 400 based on an MRAM structure 402. At least one MRAM cell 400 may be embedded with AI logic circuits in the CNN forward propagation calculation on a same semiconductor substrate in a single chip configuration. The single-chip AI engine with the at least one embedded MRAM cell 400 may be fabricated based on a CMOS fabrication technology. Exemplary implementation for integrating CNN logic circuits and MRAM may be found in U.S. patent application Ser. No. 15/989,515, U.S. patent application Ser. No. 15/838,131, U.S. patent application Ser. No. 15/726,084, U.S. patent application Ser. No. 15/642,100, and U.S. patent application Ser. No. 15/642,076 by the same Applicant as the current application, which are incorporated herein by reference in their entireties. For example, the embedded MRAM cell 400 may be based on spin torque transfer (STT) type of magnetic tunnel junctions (MTJs). Each MTJ 402 may include a magnetic tunnel layer 406 sandwiched between a free magnetic layer 404 and a pinned magnetic layer 408. The free magnetic layer 404 of the MTJ layer may comprise CoxFeyBz, FexBy, FexBy/CoxFeyBz, CoxFeyBz/CoxFeyBz, CoxFeyBz/M/CoxFeyBz, FexBy/M/FexBy or FexBy/CoxFeyBz/M/CoxFeyBz, wherein M is metal.

These MRAM cell 400 may be designed to achieve read access time faster than 10 nanosecond, faster than 5 nanosecond, or faster than 2 nanosecond. These MRAM cells may further be designed with high density and small cell size. For an MRAM cell, the MTJ may be formed with a width raging from 20 nm to 200 nm.

The MRAM cell 400 may further include bit line 420, word line 460, and source line 430. The source line 430, for example, may be connected to source of transistor 410 and the word line 460 may be connected to the gate of the transistor 410. The drain of the transistor may be connected to the pinned magnetic layer 408. The free magnetic layer 404 may be connected to the bit line 420. While the magnetic moment of the pinned layer may be fixed, the magnetic moment of the free layer may be programed either parallel or antiparallel to that of the pinned layer, representing one and zero of the MRAM cell, respectively. The programming of the cell into binary zero and binary one may be achieved by electric current pulses flowing in opposite directions through the MTJ 402. The implementation of the MTJ 402 in FIG. 4 is an example only. In some other implementations, the free magnetic layer 404 and the pinned magnetic layer 408 may be switched. In particular, the free magnetic layer 404 may be below the magnetic tunneling layer 406 and connected to the drain of the transistor 410 while the pinned magnetic layer 408 may be above the magnetic tunneling layer 406 and connected to the bit line 420.

The programing or writing of the MRAM cell of FIG. 4 may be asymmetric. For example, it may take larger current or take longer time to write one than to write zero. Because of such data access asymmetry, data access error for ones and zeros may be different or asymmetric. For example, the probability of mistakenly writing one as zero may be higher than the probability of mistakenly writing zero as one.

Such data access asymmetry and resulting data access error asymmetry may be modified by adjusting the MRAM cell structure in size or in design, using different materials, or using different fabrication processes. In some other implementations, the etch profile of the MTJ structure may be modified to adjust the data access asymmetry. In yet some other implementations, the magnetic moments of the pinned magnetic layer 408 and/or the free magnetic layer 404 may be adjusted in absolute and/or relative values to modify the data access asymmetry. In some other implementations, the composition of the junction layer (e.g., Mg composition in MgO) may be adjusted to modify the data access asymmetry. In yet some other implementations, the roughness of the MTJ structure may be adjusted to modify the data access asymmetry. The above adjustments may further be combined in any manner to modify the data access asymmetry.

Those having ordinary skill in the art understand that the memory cell based on MRAM above is merely an example. Other memory technologies may also be used. These technologies may include but are not limited to phase change random access memory (PCRAM), resistive random access memory (RRAM), and static random access memory (SRAM). These technologies may also be characterized by data writing/reading (access) asymmetry and corresponding writing/reading (access) error asymmetry. Likewise, the data access asymmetry and access error asymmetry may be modified by adjusting, e.g., the design, profile, material composition, and fabrication process for these memory cells.

The description above thus indicates that, in one aspect, a trained CNN model may be characterized by binary data asymmetry in its model parameters (including an overall binary data asymmetry as well as binary data asymmetry within one or more types of model parameters) and may further be characterized by bit-inversion tolerance asymmetry (again, including an overall bit-inversion tolerance asymmetry as well as bit-inversion tolerance asymmetry due to one or more types of model parameters). The description above also indicates that, in another aspect, the memory cells used for storing the model parameters of a trained CNN model may be characterized by data writing/reading (access) asymmetry and corresponding writing/reading (access) error asymmetry, and these asymmetries may be adjusted or shifted by modifying, e.g., the memory cell geometric/architectural design, material composition, and fabrication process. In the disclosure below, various implementations are further described for adapting, matching, shifting, and/or adjusting memory cell data access asymmetry and data access error asymmetry according to the binary data asymmetry of the model parameters and bit-inversion tolerance asymmetry of the CNN model to achieve more fault-tolerant and more accurate AI system with embedded memory. Such improvement may be achieved by adjustment in memory design and fabrication that modify the data access asymmetry and data access error asymmetry without having to improve the overall data access error rate and without having to include significant amount of redundant memory cells with error correction codes. In other words, shifting potential data access errors between zero bits and one bits (modifying data access error asymmetry) may improve model accuracy solely based on the asymmetry characteristics of the AI model parameters.

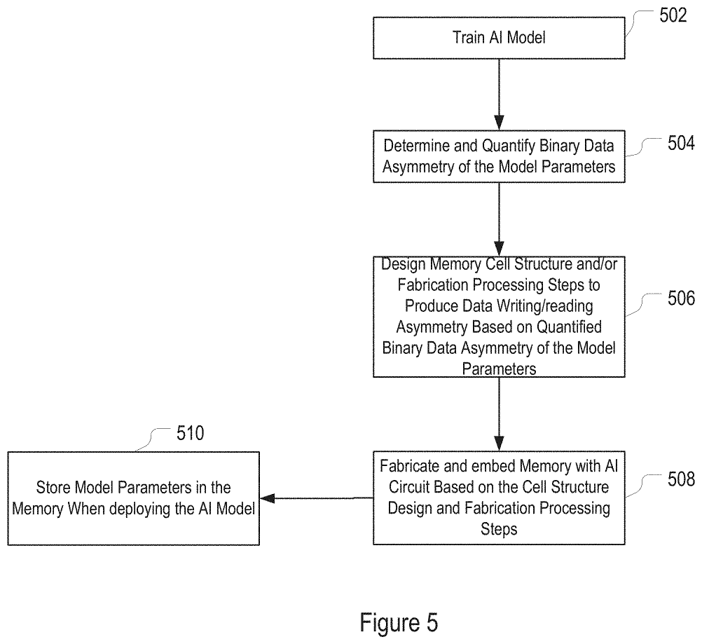

FIG. 5 illustrates an exemplary logic flow for one of such implementations. In the implementation of FIG. 5, a CNN model, or generally, an AI model is trained (502) in a reliable computing system to obtain model parameters. The binary data asymmetry of the model parameters may then be analyzed (504). The binary data asymmetry may be further quantified (504). For example, the number of zeros and number of ones of the model parameters in binary form may be counted and their imbalance (e.g., ratio between a difference of the zeros and ones and the total number of bits) may be used to quantify the binary data asymmetry. Then the memory cell structure and fabrication process may be designed for producing data access asymmetry based on the quantified binary data asymmetry of the model parameters. For example, it may be difficult to design and fabricate memory cells to reduce both errors rates for writing/reading ones and writing/reading zeros. It may, however, be much easier to design and fabricate memory cells with error rate shifting between zeros and ones. In other words, the memory cells may be designed and fabricated to favor more accurate writing/reading for one of the two binary values than the other of the two binary values even though the overall writing/reading error rate is not significantly improved. Specifically, when the CNN model to be stored in the memory is zero-dominant, the memory cells may be correspondingly designed and fabricated to have better writing/reading accuracy for binary zero. Conversely, when the CNN model to be stored in the memory is one-dominant, the memory cells may be correspondingly designed and fabricated to have better writing/reading accuracy for binary one. As such, overall accuracy and error tolerance of the model may be achieved. In one implementation, the binary data asymmetry of the model parameter and the error rate imbalance may follow a proportional relationship.

Continuing with FIG. 5, once the memory structure and fabrication process are designed based on the binary data asymmetry in the model parameters, the embedded memory may be fabricated with the AI circuit (508) and the model parameters may be stored in the memory cells when the model is deployed (510).

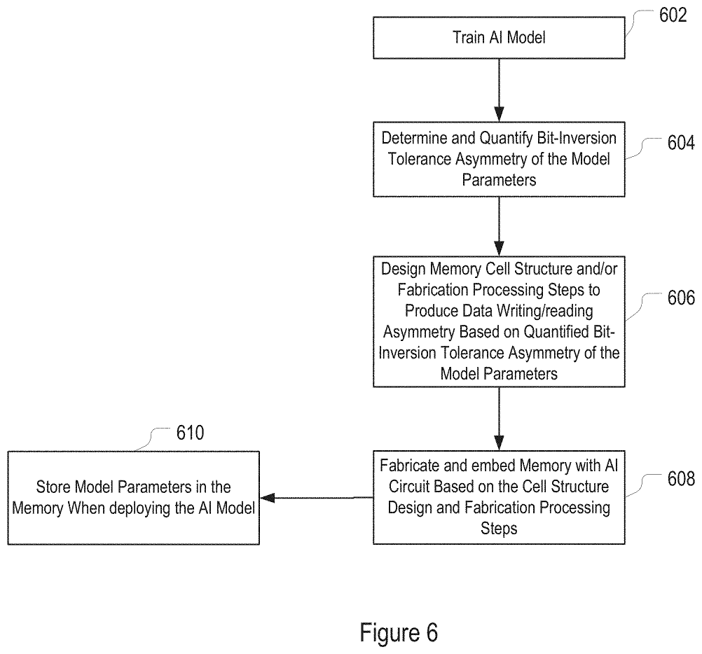

FIG. 6 illustrates a logic flow for an exemplary implementation in adapting the memory data access asymmetry and data access error asymmetry to bit-inversion tolerance asymmetry of a CNN model. In the implementation of FIG. 6, a CNN model, or generally, an AI model is trained (602) in a reliable computing system to obtain model parameters. An overall bit-inversion tolerance asymmetry of the model may then be determined (604). The overall bit-inversion tolerance asymmetry may be further quantified (604) as described above. To reiterate, a predetermined number of zero bits in the model parameters may be intentionally inverted to ones in a random manner among all bits of all model parameters. The randomly inverted model parameters may then be used for forward propagation of the training data (or other pre-labeled data not used for training) to produce outputs. Prediction error rate (as determined by comparing the outputs to pre-labels) may be recorded for a set of input data. The process may be repeated for different sets of random zero-to-one inversions of the same predetermined number of inverted bits. The process above may further be repeated for inverting different predetermined numbers of bits (one bit, 2 bit, 3 bit, etc.). The various error rates determined above for different number of inverted bits may be weight-averaged (or collectively processed in other manner) to represent the overall zero-to-one bit-inversion tolerance characteristics for the trained model.

Continuing with FIG. 6, then the memory cell structure and fabrication process may be designed for producing data access asymmetry based on the quantified overall bit-inversion tolerance asymmetry of the model (606). As discussed above, it may be difficult to design and fabricate memory cells to reduce errors rate for both writing ones and writing zeros. It may, however, be much easier to design and fabricate memory cells with error rate shifting between zeros and ones. In other words, the memory cells may be designed and fabricated to favor more accurate access for one of the two binary values even though the overall data access error rate is not significantly improved. Specifically, when the CNN model to be stored in the memory is more tolerant for inadvertent inversion from zero to one, the memory cells may be correspondingly designed and fabricated to have better data access accuracy for binary one. Conversely, when the CNN model to be stored in the memory is more tolerant for inadvertent inversion from one to zero, the memory cells may be correspondingly designed and fabricated to have better data access accuracy for binary zero.

Further continuing with FIG. 6, once the memory structure and fabrication process are designed based on the bit-inversion asymmetry of the CNN model, the embedded memory may be fabricated with the AI circuit (608) and the model parameters may be stored in the memory cells when the CNN model is deployed (610).

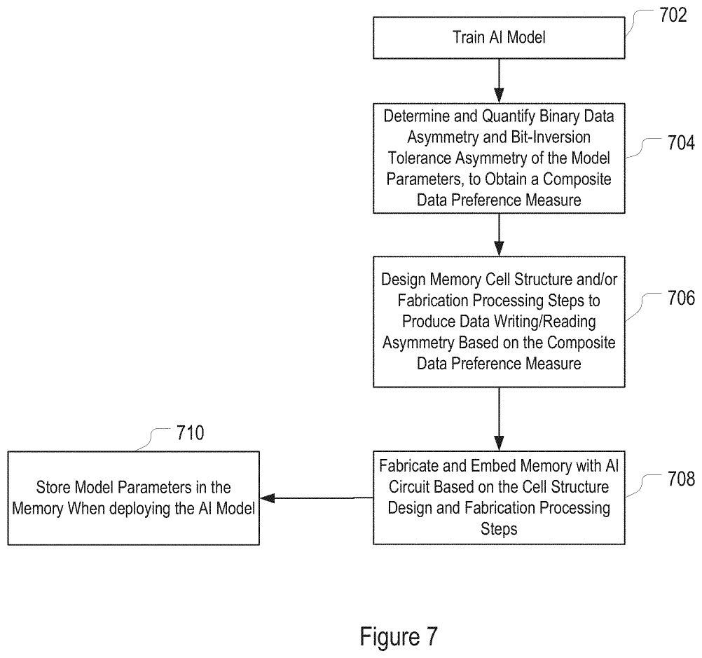

FIG. 7 illustrates a logic flow for an exemplary implementation in adapting the memory data access asymmetry and data access error asymmetry to a composite data preference measure of a CNN model. FIG. 7 is essentially a combination of the implementations in FIG. 5 and FIG. 6. In particular, rather than adapting the memory to either a binary data asymmetry of the model parameters or a bit-inversion tolerance asymmetry of the model, FIG. 7 combines the binary data asymmetry of the model parameters and the bit-inversion tolerance asymmetry into the composite data preference measure of the CNN model. In particular, when both of the binary data asymmetry and the bit-inversion tolerance asymmetry call for the same memory data access asymmetry and data access error asymmetry, then the binary data asymmetry and the bit-inversion tolerance asymmetry forming a reinforced composite data preference measure to promote such memory design. On the other hand, when the binary data asymmetry and the bit-inversion tolerance asymmetry pull in opposite directions as to which data access asymmetry and data access error asymmetry should be used for the memory, the stronger one of the data asymmetry and the bit-inversion tolerance asymmetry wins. The conflicting binary data asymmetry and bit-inversion asymmetry may be weighed differently in forming the composite data preference measure. As such, the composite data preference measure may be first determined and quantified (704). The memory data access asymmetry and data access error asymmetry may then be determined based on the composite data preference measure of the CNN model (706). The remaining flow steps in FIG. 7, such as step 702, 708 and 710 are similar to the corresponding steps in FIG. 5 and FIG. 6.

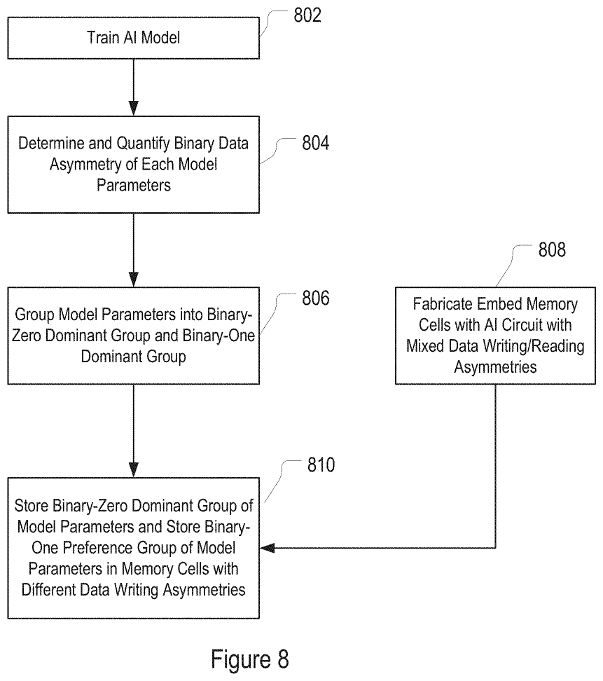

FIG. 8 illustrates a logic flow for another exemplary implementation for fabricating memory cells with mixed data access asymmetries and use such memory cells of different data access asymmetries for storing model parameters with different binary data asymmetries. In the implementation of FIG. 8, a CNN model, or generally, an AI model is trained (802) in a reliable computing system to obtain model parameters. The binary data asymmetry for each model parameters may then be determined (804). The binary data asymmetry for each model parameter may be further quantified (804) in a similar manner as described above for 504 of FIG. 5 (by counting numbers of zeros and ones in each model parameter). The model parameters may then be grouped into a binary-zero dominant group and a binary-one dominant group (806). Memory cell structure and fabrication process may be designed for producing memory cells embedded in AI logic circuit with mixed data access asymmetries and data access error asymmetries (808). Then the groups of model parameters are stored in memory cells with different data access asymmetries (810). In particular, the model parameters within the binary-zero dominant group may then be stored in the memory cells that write zeros with fewer potential errors. Conversely, the model parameters within the binary-one dominant group may be stored in the memory cells that write ones with fewer potential errors.

In one variation of the implementation of FIG. 8, binary data asymmetry may be quantified for different types of model parameters (e.g., kernels, weights, biases). Each type of model parameters may be stored in memory cells having compatible data access asymmetry and data access error asymmetry among the memory cells with mixed asymmetries.

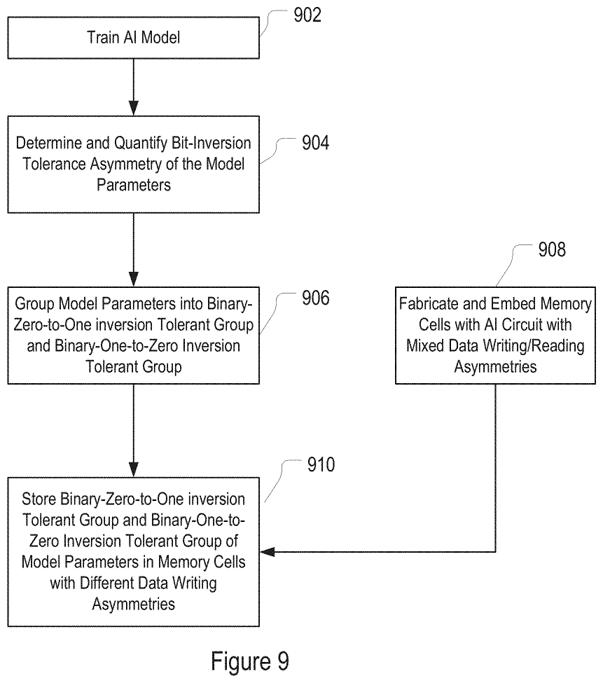

FIG. 9 illustrates a logic flow for another exemplary implementation for fabricating memory cells with mixed data access asymmetries and use such memory cells of different data access asymmetries for storing model parameters with different bit-inversion tolerance asymmetries. In the implementation of FIG. 9, a CNN model, or generally, an AI model is trained (902) in a reliable computing system to obtain model parameters. The bit-inversion tolerance asymmetry for each model parameters may then be determined (904). The bit-inversion tolerance asymmetry for each model parameter may be further quantified (904) in a similar manner as described in various different paragraphs above. The model parameters may then be grouped into a binary-zero-to-one inversion tolerant group and a binary-one-to-zero inversion tolerant group (906). Memory cell structure and fabrication process may be designed for producing memory cells embedded in AI logic circuit with mixed data access asymmetries and data access error asymmetries (908). Then each group of model parameter may be stored in memory cells with different data access asymmetries (910). In particular, the model parameters within the binary-zero-to-one inversion tolerant group may then be stored in the memory cells that writes zeros with higher error. Conversely, the model parameters within the binary-one-to-zero tolerant group may be stored in the memory cells that writes ones with higher error.

In one variation of the implementation of FIG. 9, bit-inversion tolerance asymmetry may be quantified for different types of model parameters (e.g., kernels, weights, biases). Each type of model parameters may be stored in memory cells having compatible data access asymmetry and data access error asymmetry among the memory cells with mixed asymmetries.

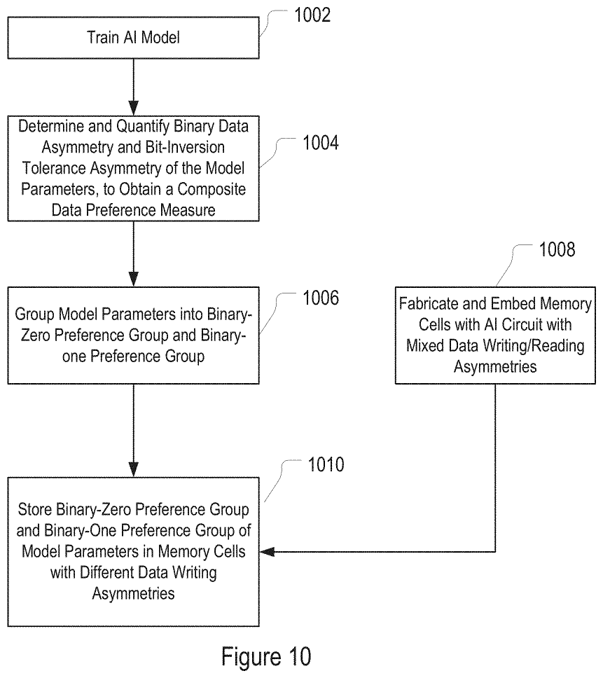

FIG. 10 illustrates a logic flow for another exemplary implementation for fabricating memory cells with mixed data access asymmetries and using such memory cells of different data access asymmetries for storing model parameters with different composite data preference measure. FIG. 10 is essentially a combination of the implementations in FIG. 8 and FIG. 9. In particular, rather than using memory with mixed data access asymmetries based on either a binary data asymmetry of the model parameters or a bit-inversion tolerance asymmetry of the model, FIG. 10 combines the binary data asymmetry of the model parameters and the bit-inversion tolerance asymmetry into the composite data preference measure of the model (see description for FIG. 7 for composite data preference measure of the model) (1004). As such, the grouping of the model parameters are also based on the composite data preference measure (1006). The remaining flow steps in FIG. 10, such as step 1002, 1008 and 1010 are similar to the corresponding steps in FIG. 8 and FIG. 9.

In one variation of the implementation of FIG. 10, composite data preference measure may be quantified for different types of model parameters (e.g., kernels, weights, biases). Each type of model parameters may be stored in memory cells having compatible data access asymmetry and data access error asymmetry among the memory cells with mixed asymmetries.

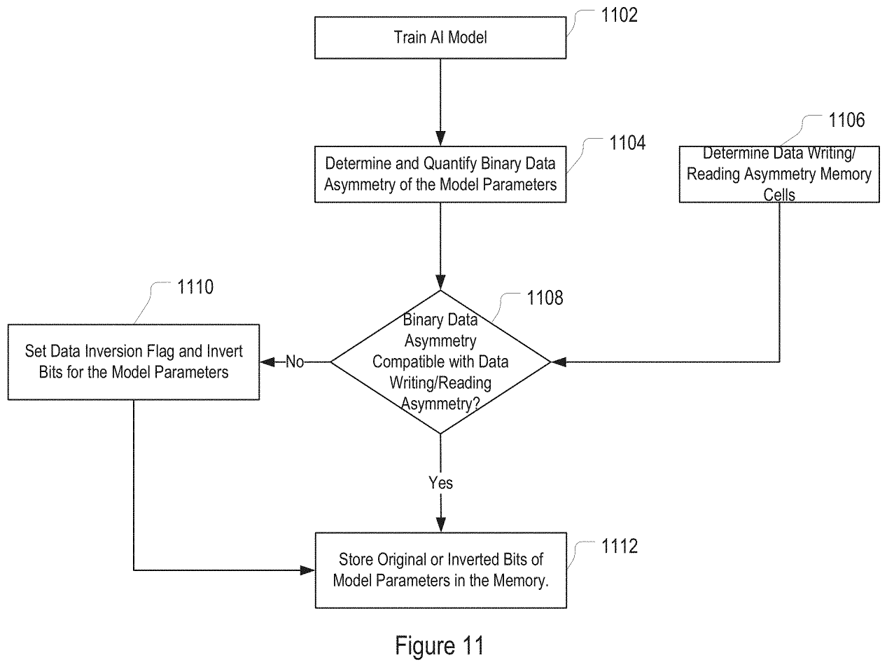

FIG. 11 illustrates an exemplary logic follow for using memory cells having a predetermined data access asymmetry by converting the model binary data for the model parameter for storage in the memory cells. Conceptually, when a memory with predetermined data access asymmetry is used and when the binary data asymmetry of the CNN model is compatible with the memory data access asymmetry, then the model parameters are stored in the memory cells as is. However, when the binary data asymmetry of the CNN model is not compatible with the memory data access asymmetry, then the model parameters are inverted bit-wise before being stored in the memory cells.

Particularly in FIG. 11, a CNN model, or a general AI model is trained (1102). The binary data asymmetry of the model parameters is then determined and quantified 1104. The memory cell data access asymmetry is also determined (1106). If the binary data asymmetry of the model parameters is consistent or compatible with the memory data access asymmetry, then the model parameter data is stored as is (1108 and 1112). However, if the binary data asymmetry of the model parameters is inconsistent or incompatible with the memory data access asymmetry, then a data inversion flag is set and the data bits of the model parameters are inverted (1108 and 1110). The inverted model parameters are stored in the memory cells (112). The data inversion flag may be used at reading stage to correctly interpret the data being read. In particular, if the flag is set, then the data read from the memory should be inverted before being used for forward propagation for the CNN model deployment.

In some other Implementations alternative to FIG. 11, bit-inversion tolerance asymmetry of the model or composite data preference measure of the model rather than the binary data asymmetry of the model parameters may be used, similar to discussion above with respect to FIGS. 6, 7, 9, and 10.

According to the various implementations above in FIGS. 5-11 for adapting memory structure, profile, material composition, and fabrication process to data characteristics of an AI model, the AI device in FIG. 1 may include the AI circuits 130 and an AI model and model parameters with various binary data asymmetry and/or bit-inversion tolerance asymmetry stored in the embedded memory 110 that are accordingly adapted to improve model accuracy and error tolerance. Variation of such devices are also within the scope of this disclosure.

The description and accompanying drawings above provide specific example embodiments and implementations. Drawings containing circuit and system layouts, cross-sectional views, and other structural schematics, for example, are not necessarily drawn to scale unless specifically indicated. Subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

From the foregoing, it can be seen that this disclosure relates to AI circuits with embedded memory for storing trained AI model parameters. The embedded memory cell structure, device profile, and/or fabrication process are designed to generate binary data access asymmetry and error rate asymmetry between writing binary zeros and binary ones that are adapted to and compatible with a binary data asymmetry of the trained model parameters and/or a bit-inversion tolerance asymmetry of the AI model between binary zeros and ones. The disclosed method and system improves predictive accuracy and memory error tolerance without significantly reducing an overall memory error rate and without relying on memory cell redundancy and error correction codes.

What is claimed is:

1. A method for classifying input data into a set of classes, comprising:
training a convolutional neural network (CNN) model using a set of training input data each labeled with one of the set of classes to obtain a plurality of model parameters;
determining a data preference measure of the model parameters;
determining an acceptable range of memory cell data access asymmetry according to the data preference measure of the model parameters;
adjusting memory cell design and fabrication process to generate an array of memory cells having a data access asymmetry within the acceptable range of memory cell data access asymmetry;
embedding the array of memory cells with an artificial intelligence (AI) logic circuit to form an AI device;
loading the trained CNN model into the AI device by at least loading the model parameters with the data preference measure into the array of memory cells having the data access asymmetry; and
forward-propagate an input data through the trained CNN model using the model parameters loaded in the array of memory cells to determine an output class among the set of classes for the input data.

2. The method of claim 1, wherein the data preference measure of the model parameters quantifies an imbalance between a number of zeros and a number of ones of the model parameters each expressed in a predetermined multi-bit binary form.

3. The method of claim 1, wherein the data preference measure of the model parameters quantifies a bit-inversion tolerance asymmetry of the CNN model.

4. The method of claim 3, wherein the bit-inversion tolerance asymmetry of the CNN model is determined by:
repeatedly inverting a predetermined number of bits of the model parameters having a value of zero to one to generate statistically a first prediction error rate of the CNN model using the set of training input data and the zero-to-one inverted model parameters;
repeatedly inverting a predetermined number of bits of the model parameters having a value of one to zero to generate statistically a second prediction error rate of the CNN model using the set of training input data and the one-to-zero inverted model parameters;
and determining an imbalance between the first prediction error rate and the second prediction error rate as the bit-inversion tolerance asymmetry of the CNN model.

5. The method of claim 1, wherein the data preference measure of the model parameters quantifies a composite of a bit-inversion tolerance asymmetry of the CNN model and an imbalance between a number of zeros and a number of ones of the model parameters each expressed in a predetermined multi-bit binary form.

6. The method of claim 1, wherein each memory cell of the array of memory cells comprises a magnetic tunnel junction comprising a thin insulating layer sandwiched by a permanent ferromagnetic plate and a writable ferromagnetic plate.

7. The method of claim 1, wherein the data access asymmetry comprises an asymmetry between error rate in writing binary one and error rate in writing binary zero.

8. A method for classifying input data into a set of classes, comprising:
training a CNN model using a set of training input data each labeled with one of the set of classes to obtain a plurality of model parameters;
dividing the plurality of model parameters into a first group of model parameters with a first data preference measure and a second group of model parameters with a first data preference measure opposite to the first data preference measure;
adjusting memory cell design and fabrication process to generate an array of memory cells comprising a first set of memory cells having a first data access asymmetry and a second set of memory cells having a second data access asymmetry opposite to the first data access asymmetry;
embedding the array of memory cells with an AI logic circuit to form an AI device;
loading the trained CNN model into the AI device by at least loading the first group of model parameters into the first set of memory cells and the second group of model parameters into the second set of memory cells; and
forward-propagate an input data through the trained CNN model using the model parameters loaded in the array of memory cells to determine an output class among the set of classes for the input data.

9. The method of claim 8, wherein the data preference measure of the model parameters quantifies an imbalance between a number of zeros and a number of ones of the model parameters each expressed in a predetermined multi-bit binary form.

10. The method of claim 8, wherein the data preference measure of the model parameters quantifies a bit-inversion tolerance asymmetry of the CNN model.

11. The method of claim 10, wherein the bit-inversion tolerance asymmetry of the CNN model is determined by:
repeatedly inverting a predetermined number of bits of the model parameters having a value of zero to one to generate statistically a first prediction error rate of the CNN model using the set of training input data and the zero-to-one inverted model parameters;
repeatedly inverting a predetermined number of bits of the model parameters having a value of one to zero to generate statistically a second prediction error rate of the CNN model using the set of training input data and the one-to-zero inverted model parameters;
and determining an imbalance between the first prediction error rate and the second prediction error rate as the bit-inversion tolerance asymmetry of the CNN model.

12. The method of claim 8, wherein the data preference measure of the model parameters quantifies a composite of a bit-inversion tolerance asymmetry of the CNN model and an imbalance between a number of zeros and a number of ones of the model parameters each expressed in a predetermined multi-bit binary form.

13. The method of claim 8, wherein each memory cell of the array of memory cells comprises a magnetic tunnel junction comprising a thin insulating layer sandwiched by a permanent ferromagnetic plate and a writable ferromagnetic plate.

14. The method of claim 8, wherein the first data access asymmetry and the second data access asymmetry each comprises an asymmetry between error rate in writing binary one and error rate in writing binary zero.

15. A method for classifying input data into a set of classes, comprising:
training a CNN model using a set of training input data each labeled with one of the set of classes to obtain a plurality of model parameters;
determining a data preference measure of the model parameters;
determining a data access asymmetry of an array of memory cells embedded with an AI logic circuit in an AI device;
determining whether the data preference measure is compatible with the data access asymmetry;
when the data preference measure is not compatible with the data access asymmetry:
setting a data inversion flag;
inverting each binary bit of the model parameters to generated an inverted model parameters;
loading the trained CNN model into the AI device by at least loading the inverted model parameters into the array of memory cells;
when the data preference measure is compatible with the data access asymmetry, loading the trained CNN model into the AI device by at least loading the model parameters into the array of memory cells; and
forward-propagate an input data through the trained CNN model using the model parameters loaded in the array of memory cells when the data inversion flag is not set, and using the inverted model parameters followed by binary inversion when the data inversion flag is set to determine an output class among the set of classes for the input data.

16. The method of claim 15, wherein the data preference measure of the model parameters quantifies an imbalance between a number of zeros and a number of ones of the model parameters each expressed in a predetermined multi-bit binary form.

17. The method of claim 15, wherein the data preference measure of the model parameters quantifies a bit-inversion tolerance asymmetry of the CNN model.

18. The method of claim 17, wherein the bit-inversion tolerance asymmetry of the CNN model is determined by:
repeatedly inverting a predetermined number of bits of the model parameters having a value of zero to one to generate statistically a first prediction error rate of the CNN model using the set of training input data and the zero-to-one inverted model parameters;
repeatedly inverting a predetermined number of bits of the model parameters having a value of one to zero to generate statistically a second prediction error rate of the CNN model using the set of training input data and the one-to-zero inverted model parameters;
and determining an imbalance between the first prediction error rate and the second prediction error rate as the bit-inversion tolerance asymmetry of the CNN model.

19. The method of claim 15, wherein the data preference measure of the model parameters quantifies a composite of a bit-inversion tolerance asymmetry of the CNN model and an imbalance between a number of zeros and a number of ones of the model parameters each expressed in a predetermined multi-bit binary form.

20. The method of claim 15, wherein the data access asymmetry comprises an asymmetry between error rate in writing binary one and error rate in writing binary zero.
